(19) United States
(12) Patent Application Publication
(10) Pub. No.: US 2024/0277141 A1
(43) Pub. Date: Aug. 22, 2024

(54) CABINET APPARATUS

(71) Applicant: Kohler Co., Kohler, WI (US)

(72) Inventor: Alexander V. LeTourneau, Sheboygan, WI (US)

(21) Appl. No.: 18/417,882

(22) Filed: Jan. 19, 2024

Related U.S. Application Data
(60) Provisional application No. 63/446,586, filed on Feb. 17, 2023.

(51) Int. Cl. A47B 67/00

(52) U.S. Cl. CPC A47B 67/005

(57) ABSTRACT

A cabinet apparatus includes a housing and a door. The housing extends along a central vertical plane. The housing defines a storage space and an access opening into the storage space. The door has a mirror, and the mirror includes a front surface defining a mirror plane. The door is movably mounted to the housing to be alterable between a closed position and an open position. In the closed position, the door encloses the front access opening and the front surface of the mirror faces away from the housing. In the open position, the storage space is accessible via the access opening. When in the open position, the front surface of the mirror opposes the central vertical plane and an acute inclusive angle is formed between the central vertical plane and the mirror plane.

### CROSS-REFERENCE TO RELATED APPLICATIONS

This application claims priority benefit of Provisional Application No. 63/446,586 (Docket No. KOH-089-P) filed on Feb. 17, 2023, which is hereby incorporated by reference in its entirety.

### BACKGROUND

Cabinets are fixtures for use in homes and other locations. Cabinets may be used in kitchens and bathrooms and may incorporate a door with or without one or more mirrors. These doors open to allow storage of items within the cabinet, but mirror viewing angles can sometimes be comprised by opening of the door. There is a need for a cabinet having a door which positions the mirror in a wide range of suitable angles while simultaneously allowing access to the cabinet.

### BRIEF SUMMARY

The present disclosure is directed to a cabinet apparatus having a housing and a door. The housing extends along a central vertical plane. The housing defines a storage space and an access opening into the storage space. The door has a mirror, the mirror having a front surface defining a mirror plane. The door is movably mounted to the housing to be alterable between a closed position and an open position. In the closed position, the door encloses the front access opening, and the front surface of the mirror faces away from the housing. In the open position, the storage space is accessible via the access opening. When in the open position, the front surface of the mirror opposes the central vertical plane, and an acute inclusive angle is formed between the central vertical plane and the mirror plane.

In a further variation, the present disclosure is directed to a cabinet apparatus having a housing, a door, and a mounting assembly. The housing extends along a central vertical plane. The housing defines a storage space and an access opening into the storage space. The door has a mirror having a front surface defining a mirror plane. The mounting assembly movably mounts the door to the housing. The mounting assembly is configured to both translate and rotate the door when moving between a closed position and an open position.

In yet another further variation, the present disclosure is directed to a cabinet apparatus having a housing, a door, and a mounting assembly. The housing extends along a central vertical plane, the housing defining a storage space and an access opening into the storage space. The door has a mirror having a front surface defining a mirror plane. The mounting assembly movably mounts the door to the housing. The mounting assembly has a first arm having a first length and a second arm having a second length that is greater than the first length. The first arm has a proximal end pivotably coupled to the housing to allow the first arm to rotate relative to the housing about a first pivot axis. The first arm further has a distal end pivotably coupled to the door to allow the first arm to rotate relative to the door about a second pivot axis. The second arm has a proximal end pivotably coupled to the housing to allow the second arm to rotate relative to the housing about a third pivot axis. The second arm further has a distal end pivotably coupled to the door to allow the second arm to rotate relative to the door about a fourth pivot axis.

### BRIEF DESCRIPTION OF THE DRAWINGS

The present disclosure will become more fully understood from the detailed description and the accompanying drawings, wherein:

FIG. 1 is a perspective view of a cabinet apparatus.

FIG. 2 is a bottom rear perspective view of the cabinet apparatus.

FIG. 3 is a front view of the cabinet apparatus.

FIG. 4 is a rear view of the cabinet apparatus.

FIG. 5 is a left view of the cabinet apparatus.

FIG. 6 is a right view of the cabinet apparatus.

FIG. 7 is a top view of the cabinet apparatus.

FIG. 8 is a bottom view of the cabinet apparatus.

FIG. 9 is a cross-section view of the cabinet apparatus taken along line IX-IX of FIG. 6.

FIG. 10 is a cross-section view of the cabinet apparatus taken along line X-X of FIG. 6.

FIG. 11 is a perspective view of the cabinet apparatus with a door in an open position.

FIG. 12 is a top rear perspective view of the cabinet apparatus with the door in the open position.

FIG. 13 is a front view of the cabinet apparatus with the door in the open position.

FIG. 14 is a right view of the cabinet apparatus with the door in the open position.

FIG. 15 is a left view of the cabinet apparatus with the door in the open position.

FIG. 16 is a rear view of the cabinet apparatus with the door in the open position.

FIG. 17 is a top view of the cabinet apparatus with the door in the open position.

FIG. 18 is a bottom view of the cabinet apparatus with the door in the open position.

FIG. 19 is a cross-section view of the cabinet apparatus with the door in the open position taken along line IXX-IXX of FIG. 16.

FIG. 20 is a cross-section view of the cabinet apparatus with the door in the closed position taken along line IXX-IXX of FIG. 16.

FIG. 21 is a cross-section view of the cabinet apparatus with the door in a partially closed position taken along line IXX-IXX of FIG. 16.

FIG. 22 is a cross-section view of the cabinet apparatus with the door in a partially open position taken along line IXX-IXX of FIG. 16.

FIG. 23 is a cross-section view of the cabinet apparatus with the door in the open position taken along line IXX-IXX of FIG. 16.

FIG. 24 illustrates a flowchart for an operation of the cabinet apparatus.

FIG. 25 illustrates a block diagram for a control system for the cabinet apparatus.

FIG. 26 illustrates a block diagram for the controller of FIG. 25.

FIG. 27 illustrates a flowchart for the operation of the controller of FIG. 26.

The drawings represent one or more embodiments of the present invention(s) and do not limit the scope of invention.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

In the following description, where block diagrams or circuits are shown and described, one of skill in the art will recognize that, for the sake of clarity, not all peripheral components or circuits are shown in the figures or described in the description. For example, common components such as memory devices and power sources may not be discussed herein, as their role would be easily understood by those of ordinary skill in the art. Further, the terms “couple” and “operably couple” can refer to a direct or indirect coupling of two components of a circuit.

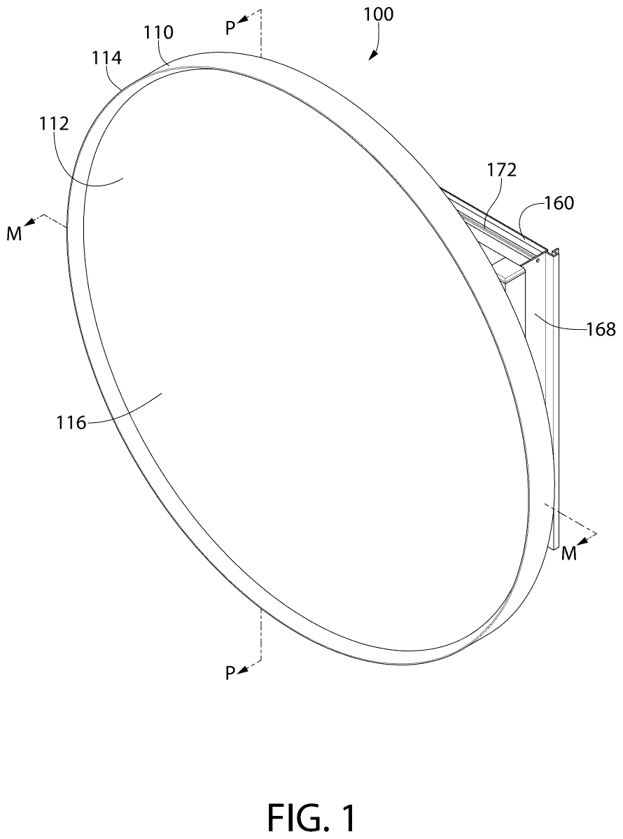

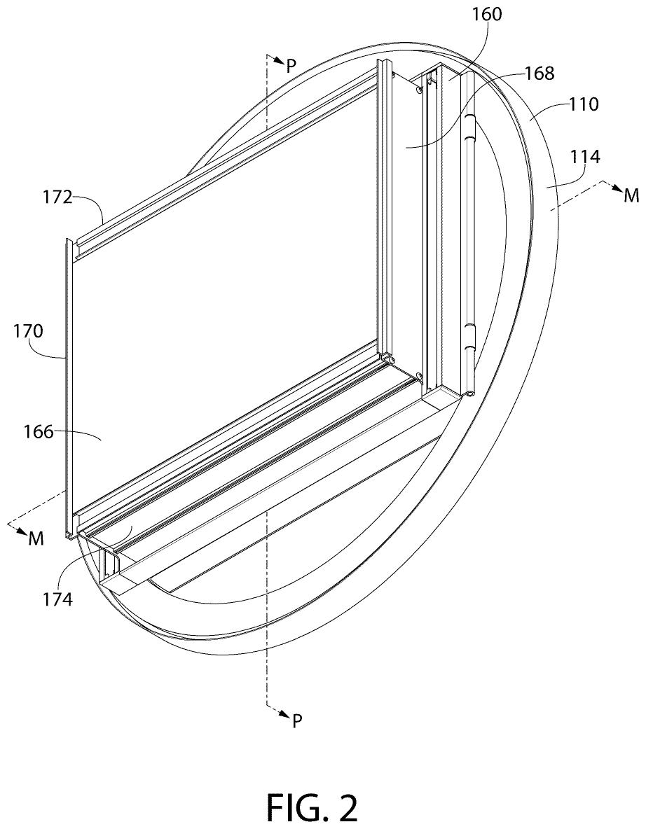

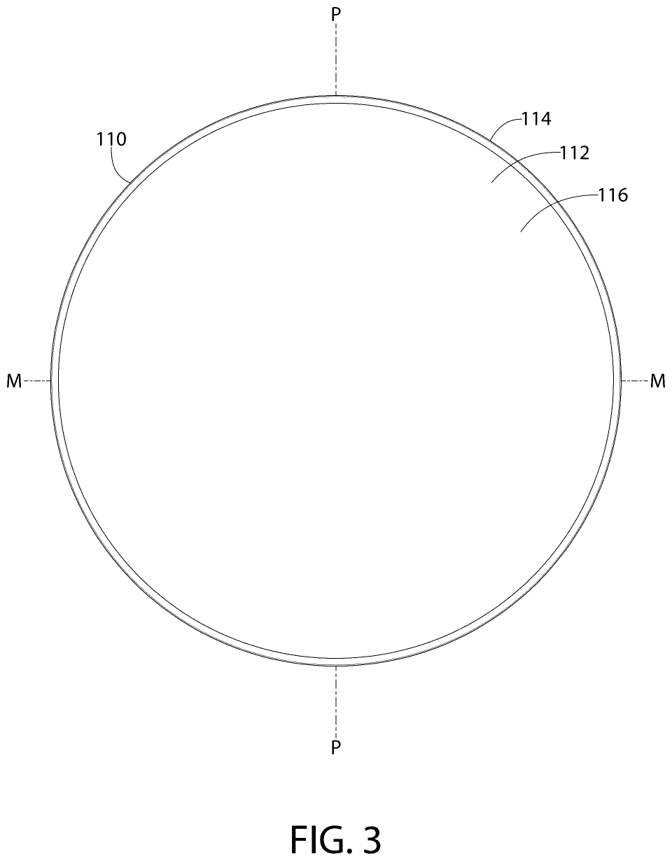

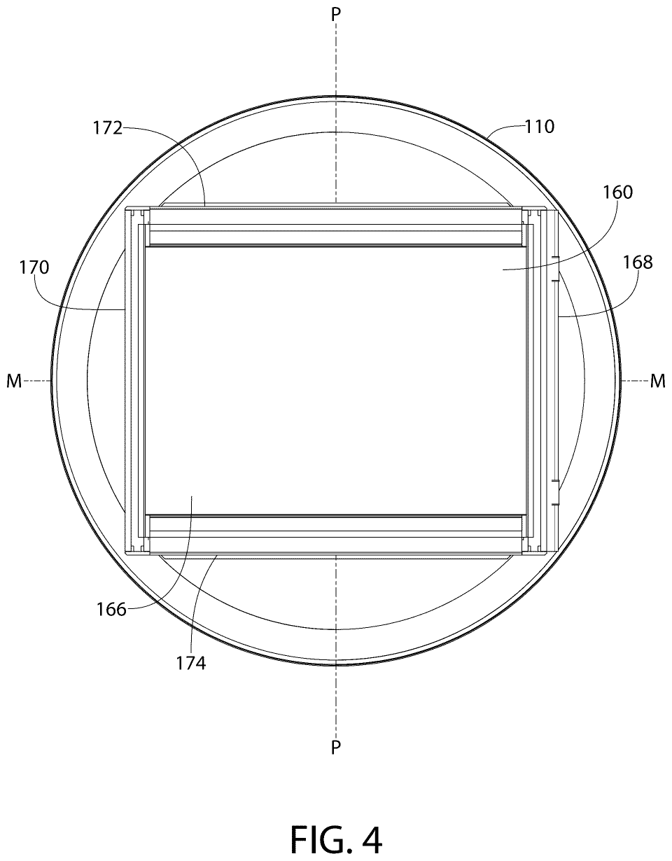

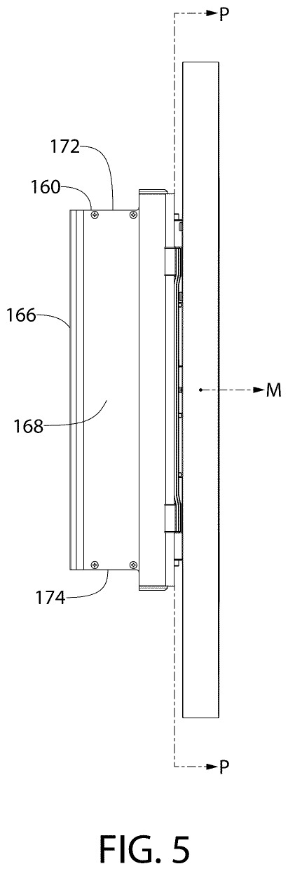

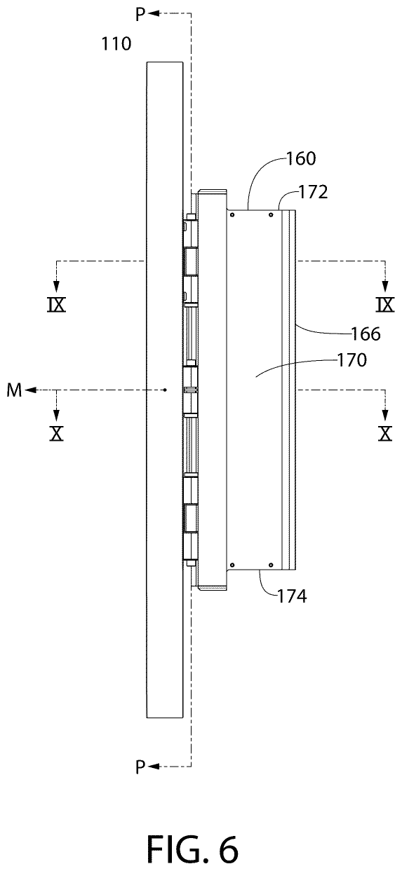

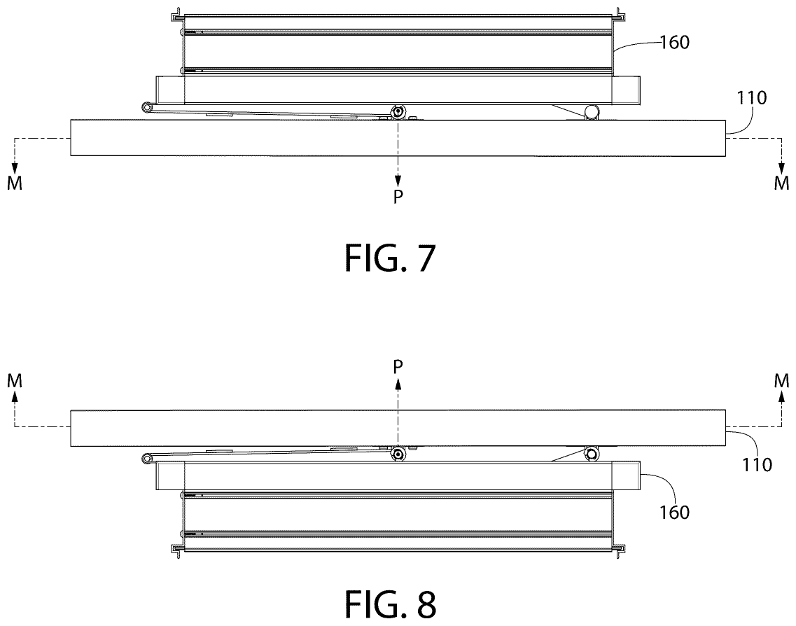

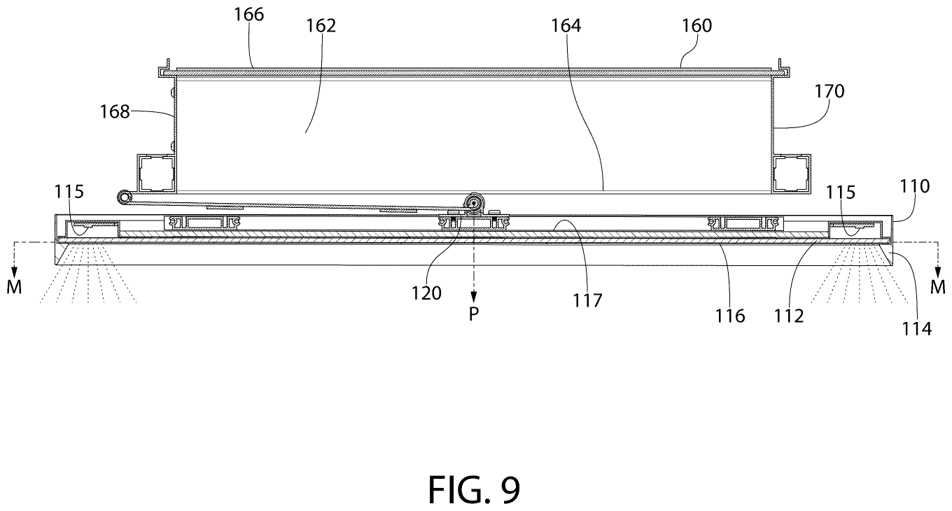

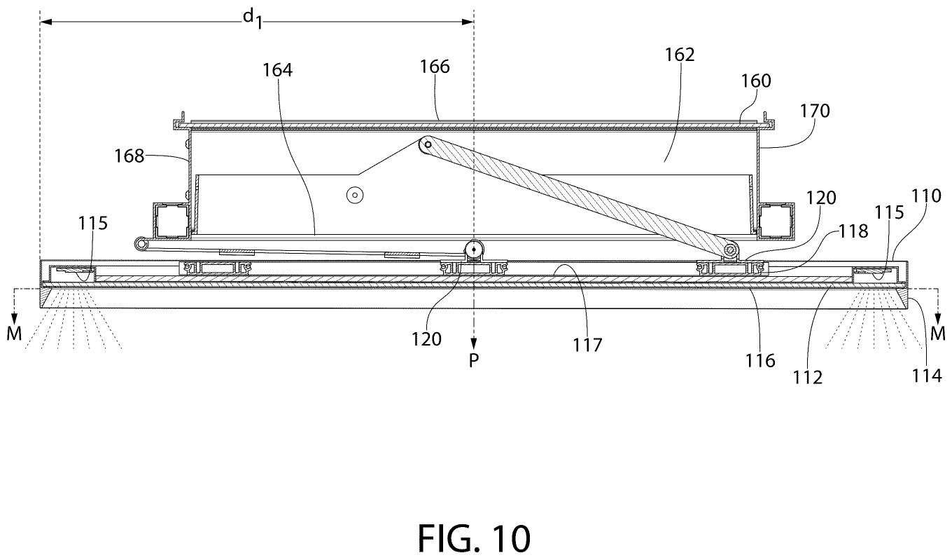

Referring now to FIGS. 1-10, a cabinet apparatus 100 is illustrated. The cabinet apparatus 100 has a door 110 and a housing 160. The housing 160 extends along a central vertical plane P-P. As illustrated, the door 110 is in a closed position. In the closed position, the door 110 covers the housing 110 and conceals the housing 160 from view by a user. The door 110 may have a mirror 112 and a bezel 114. The mirror 112 has a front surface 116 which defines a mirror plane M-M. The bezel 114 may surround the mirror 112 to provide a finished edge or the bezel 114 may be omitted. Rather than circular as illustrated, the door 110 may have any shape such as a rectangle, a square, a rounded rectangle, or other shape.

The door 110 may further incorporate a light source 115. The light source 115 may be positioned behind the mirror 112 or within the bezel 114. Where the light source 115 is positioned behind a panel of the mirror 112, the mirror 112 may be configured to allow passage of light therethrough from the light source 115 to a user. Thus, the light source 115 is configured to emit light from the front surface 116 of the mirror 112. Where the light source 115 is located within the bezel 114, the light source 115 may be configured to illuminate the mirror 112 and reflect light from the mirror 112 onto the user. The light source 115 is preferably configured to illuminate the face of a user who is standing in front of the cabinet apparatus 100. When the user is centered on the central vertical plane P-P, the light source 115 emits light onto and thus illuminates the face of the user at all positions between and including the closed position and the open position. In one embodiment, the door 110 may be free of light sources which emit light from the rear surface 117 of the door 110. In such an embodiment, the light source 115 only emits light from the front surface 116 of the mirror 112 (or from the bezel 114 of the door 110) but does not emit light from the rear surface 117 of the door 110.

In addition, the mirror 112 remains pointed at the user during the transition from the closed position to the open position. Thus, the user may view their face or other features while standing in front of the cabinet apparatus 100 and centered on the central vertical plane P-P regardless of whether the door 110 is in the open position, closed position, or any intermediate position between the open position and the closed position. In another embodiment, a display device may be incorporated into the door 110, and more specifically into the mirror 112 so that its contents are displayed through the front surface 116 of the mirror 112.

The housing 160 further incorporates a storage space 162 accessible via a front access opening 164. The storage space 162 may be used to store various articles such as toiletries, medicines, and the like. The front access opening 164 may be an opening in the front of the housing 160 suitable for placement and retrieval of the articles stored within the storage space 162. The storage space 162 may incorporate one or more shelves, drawers, or other features suitable for storing or organizing articles. The housing 160 may include a rear wall 166, left wall 168, right wall 170, top wall 172, and bottom wall 174. The housing 160 may also incorporate a flange or other feature on any of the walls to allow mounting of the cabinet apparatus 100.

The door 110 is movably mounted to the housing 160 and is alterable between a closed position and an open position. The open position will be illustrated in greater detail below. The door 110 may also incorporate a frame 118 that supports the mirror 112 and provides the structure required for the door 110. In addition, the frame 118 may incorporate a plurality of mounts 120 which may be used to attach pivot arms or other hinge components.

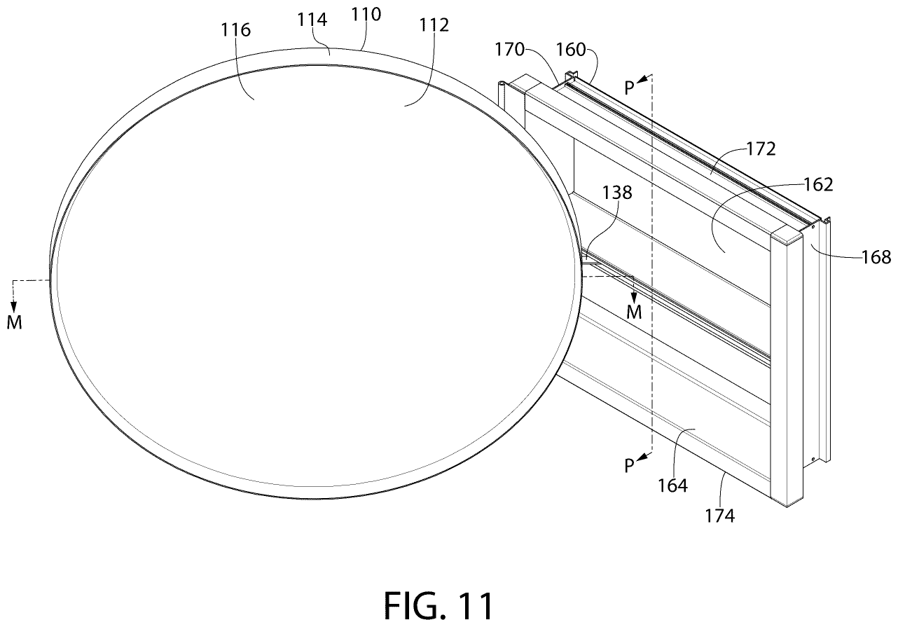

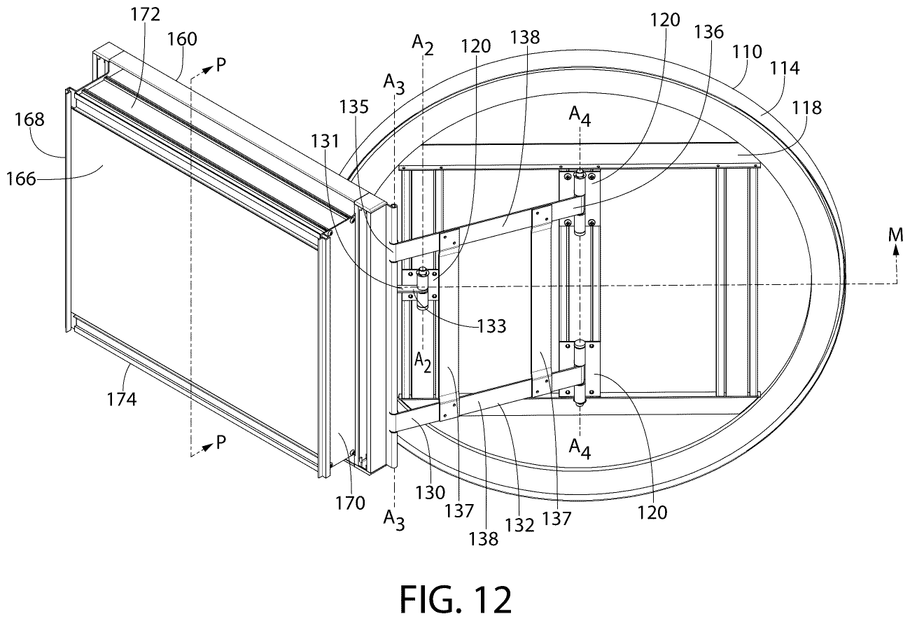

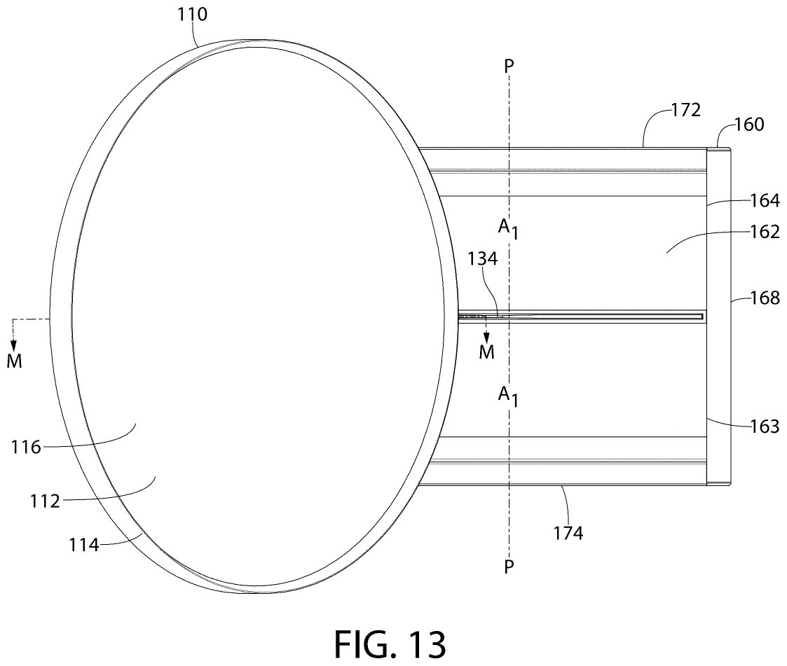

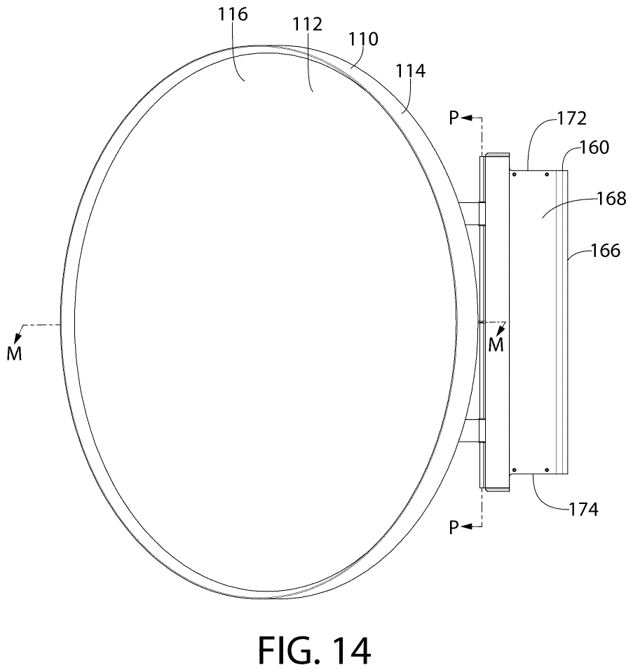

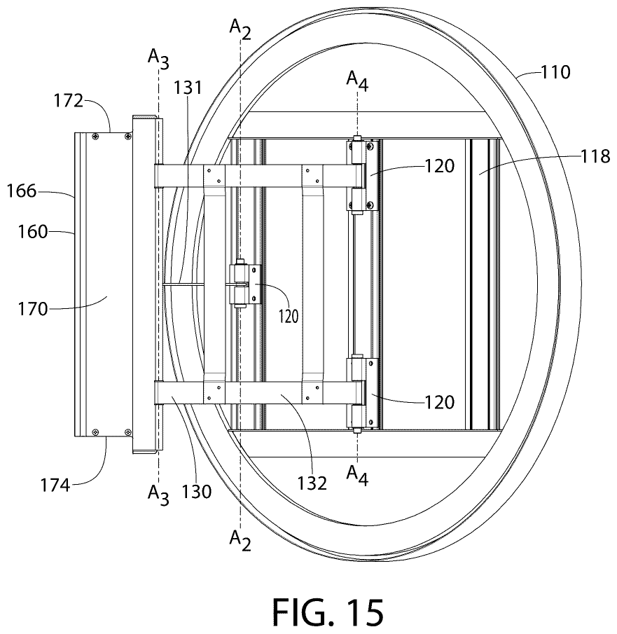

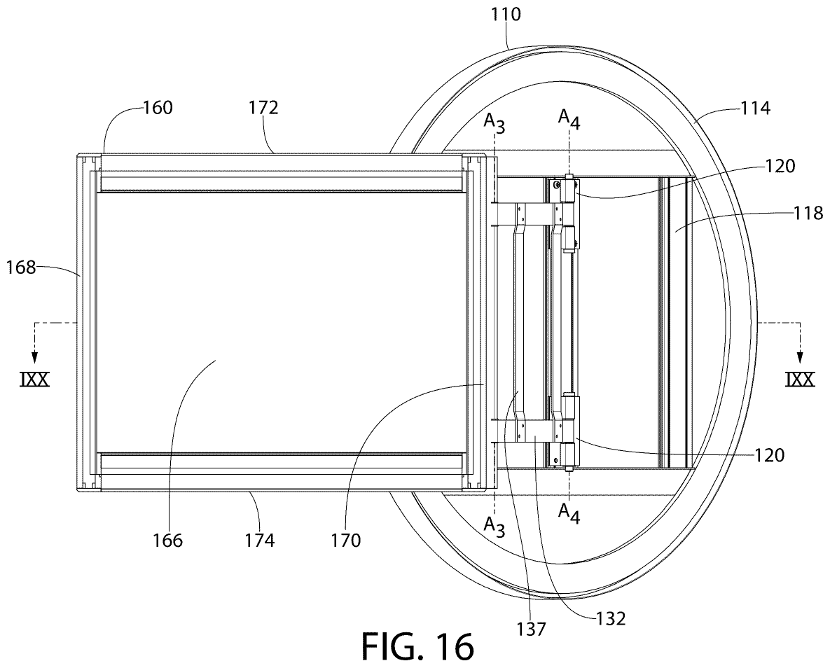

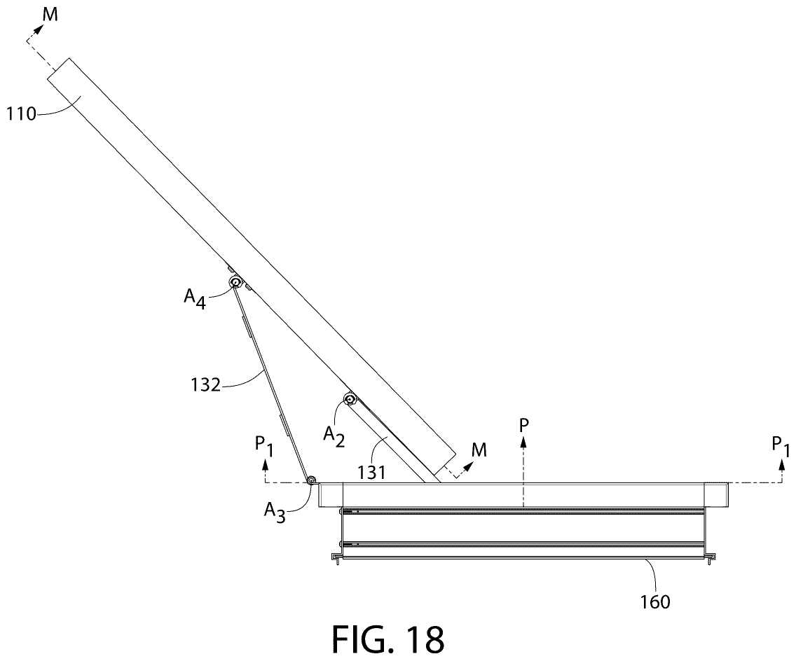

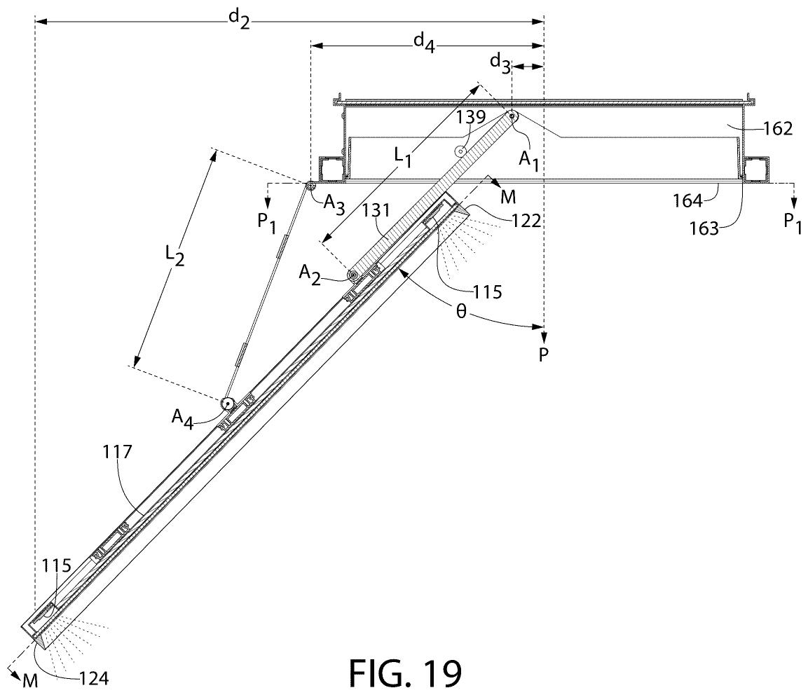

Turning to FIGS. 11-19, the cabinet apparatus 100 is illustrated in the open position. The door 110 is coupled to the housing 160 by a mounting assembly 130, the mounting assembly 130 coupled to the door 110 and the housing 160 to allow movement of the door 110 relative to the housing 160. The mounting assembly 130 has a first arm 131 and a second arm 132. The first arm 131 extends from a proximal end 133 which is pivotably coupled to the housing 160 to a distal end 134 which is pivotably coupled to a mount 120 of the door 110. The proximal end 133 of the first arm 131 allows relative rotation about a first pivot axis A₁-A₁. The distal end 134 of the first arm 131 allows relative rotation about a second pivot axis A₂-A₂.

Similarly, the second arm 132 extends from proximal end 135 which is pivotably coupled to the housing 160 to a distal end 136 which is pivotably coupled to two mounts 120 of the door 110. The number of mounts 120 which are utilized for the first arm 131 and the second arm 132 may vary as desired. The proximal end 135 of the second arm 132 allows relative rotation about a third pivot axis A₃-A₃. The distal end 136 of the second pivot arm 132 allows relative rotation about a fourth pivot axis A₄-A₄.

The first and third pivot axes A₁-A₁, A₃-A₃ are fixed relative to the housing 160 and the second and fourth pivot axes A₂-A₂, A₄-A₄ are fixed relative to the door 110. The pivot axes A₁-A₁, A₂-A₂, A₃-A₃, A₄-A₄ may extend through one or more mounts 120 of the door 110 or mounts of the housing 160. The first and second arms 131, 132 may be formed as a single link 138 like the first arm 131 illustrated in the figures. Alternately, the first and second arms 131, 132 may have two parallel links 138 like the second arm 132 illustrated in the figures. In the two parallel link 138 configuration, the links 138 may be separate or may be coupled together using additional members such as the members 137 which help to increase strength and rigidity of the mounting assembly 130 and improve vibration resistance of the door 110. In yet other implementations, cither or both of the first and second arms 131, 132 may comprise more than two links. In addition, a stopper 139 engages the first arm 131 and limits opening of the door 110. The stopper 139 prevents the door from being opened beyond the open position to avoid damage to the door 110, the mounting assembly 130, or the housing 160. Thus, the stopper 139 ensures that the open position is a fully open position, limiting further travel of the door 110 beyond the open position.

The first pivot axis A₁-A₁ is located a third orthogonal distance d₃ from the central vertical plane P-P. The third pivot axis A₃-A₃ is located a fourth orthogonal distance d₄ from the central vertical plane P-P. The fourth orthogonal distance d₄ is greater than the third orthogonal distance d₃. Thus, the proximal ends 133, 135 of the first and second arms 131, 132 are located at different distances from the central vertical plane P-P, with the proximal end 133 of the first arm 131 located closer to the central vertical plane P-P than the proximal end 135 of the second arm 132.

Furthermore, the first arm 131 has a length L₁ between the first pivot axis A₁-A₁ and the second pivot axis A₂-A₂ while the second arm 132 has a length L₂ between the third pivot axis A₃-A₃ and the fourth pivot axis A₄-A₄. The length L₂ of the second arm 132 is greater than the length L₁ of the first arm 131. This allows the door 110 to both rotate and translate with respect to the central vertical plane P-P as will be discussed in more detail below. When in the open position, an acute angle θ is formed between the central vertical plane P-P and the mirror plane M-M. As illustrated, the acute angle θ is defined by the included angle between the front surface 116 of the mirror 112 and the central vertical plane P-P, the mirror plane M-M being coplanar with the front surface 116 of the mirror 112 as noted above. Optionally, the acute angle θ may range from 30 to 60 degrees when the door 110 is in the open position. In yet other implementations, the acute angle θ may be 40 to 50 degrees. In yet other implementations, the acute angle θ may be about 45 degrees.

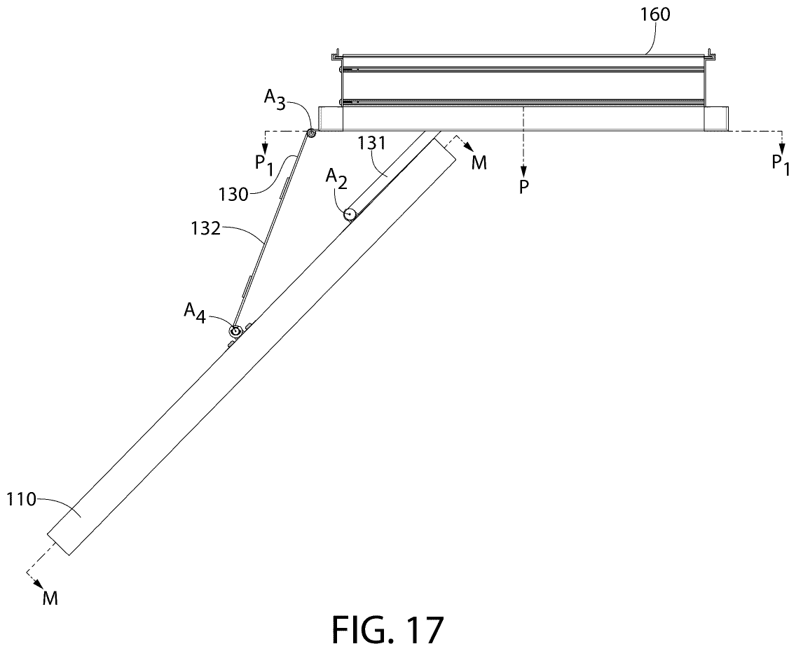

In another example the first arm 131 and/or the second arm 132 are telescoping or otherwise extendable to adjust the size of the opening 164. As shown in FIG. 17, the first arm 131 may be extended and further pivoted about an axis (e.g., A1) in order to increase the size of the opening 164.

The housing 160 further comprises an inner edge 163 which defines the access opening 164. The inner edge lies in a first plane P₁-P₁ that is orthogonal to the central vertical plane P-P. When the door 110 is in the closed position, the mirror plane M-M is substantially parallel to the first plane P1-P1. Similarly, the mirror plane M-M is perpendicular to the central vertical plane P-P when the door 110 is in the closed position.

The door 110 further comprises a first lateral edge portion 122 and a second lateral edge portion 124 opposite the first lateral edge portion 122. The first lateral edge portion 122 is located on one side of the central vertical plane P-P when the door 110 is in the closed position and on the other side of the central vertical plane P-P when the door 110 is in the open position. Thus, the first lateral edge portion 122 crosses the central vertical plane P-P when the door transitions from the closed position to the open position. The second lateral edge portion 124 is located a first orthogonal distance d₁ from the central vertical plane P-P when the door 110 is in the closed position and a second orthogonal distance d₂ from the central vertical plane P-P when the door 110 is in the open position. The second orthogonal distance d₂ is greater than the first orthogonal distance d₁.

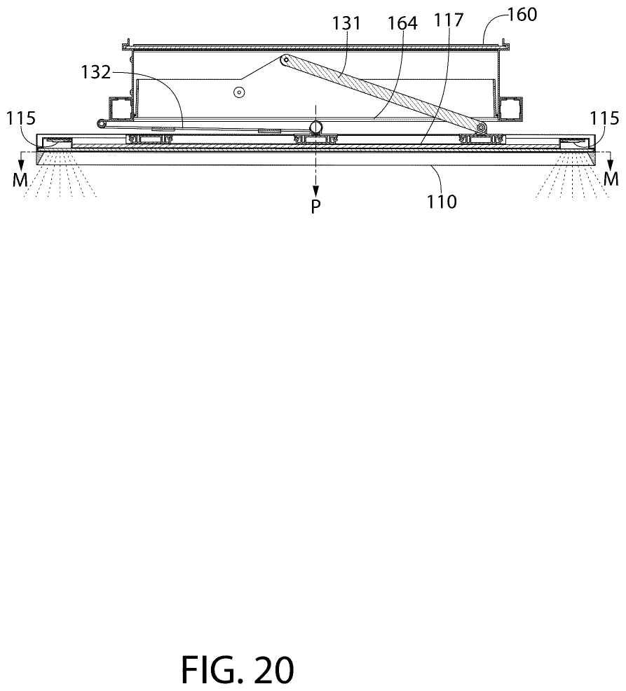

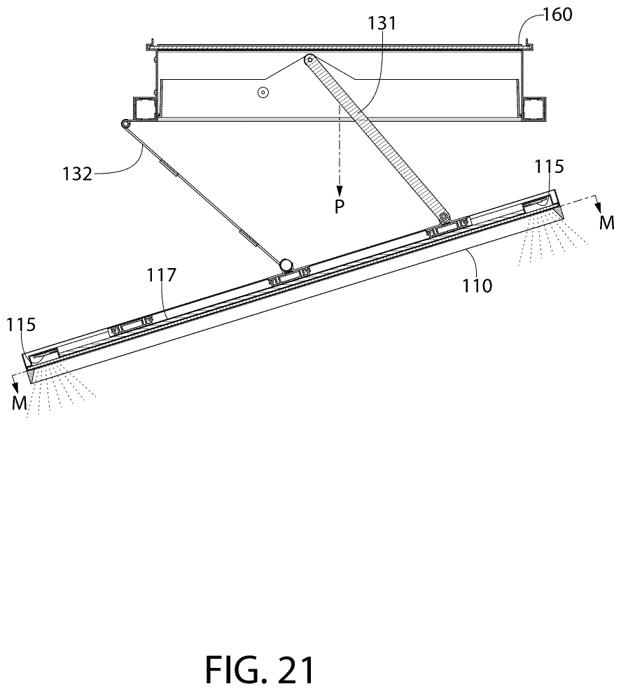

FIGS. 20-23 illustrate various states of the cabinet apparatus 100 as the door 110 transitions from the closed position to the open position, the open position being a fully open position. In FIG. 20, the door 110 is in the closed position, such that the front access opening 164 is covered by the door 110. As the door 110 is transitioned to the partially closed position from the closed position as shown in FIG. 21, the door 110 is both translated and rotated as a result of movement of the first and second arms 131, 132 rotating about their respective pivot axes A₁-A₁, A₂-A₂, A₃-A₃, A₄-A₄. The mirror plane M-M is no longer perpendicular to the central vertical plane P-P.

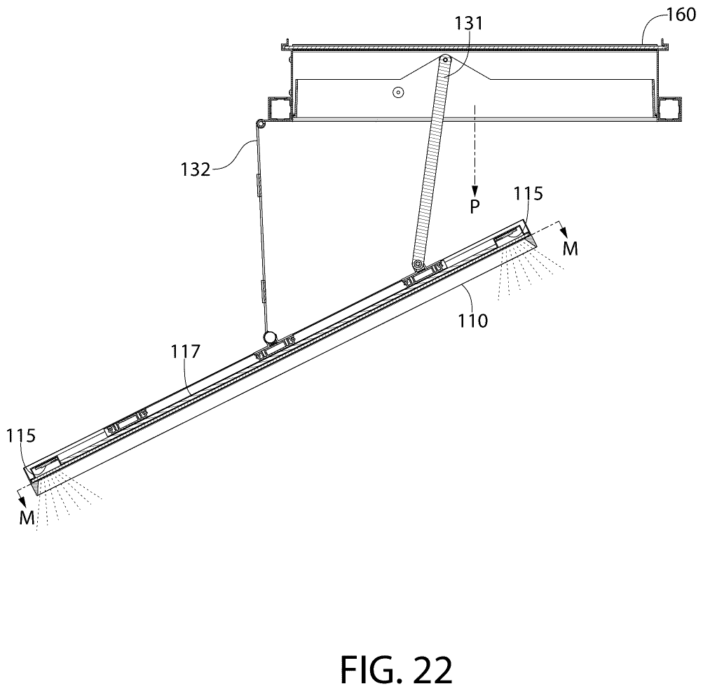

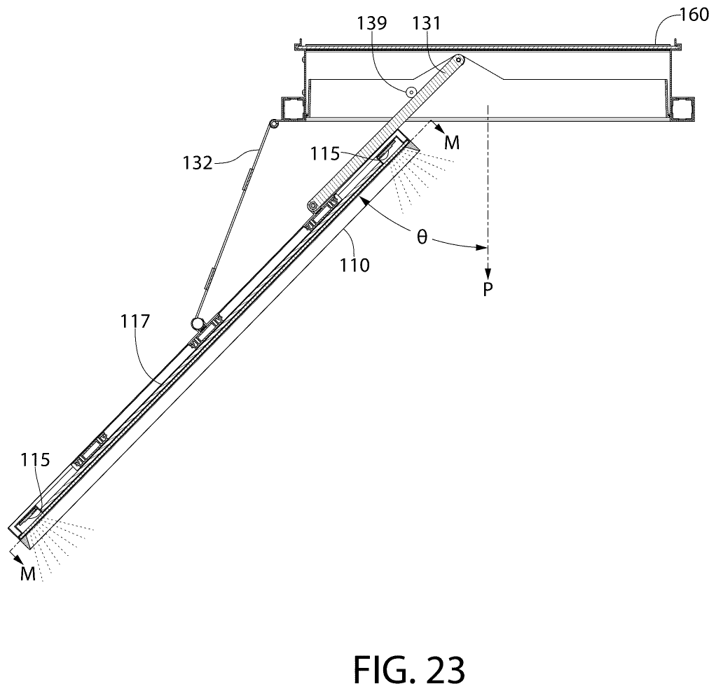

As shown in FIG. 22, the door 110 is transitioned from the partially closed position to the partially open position. The mirror plane M-M is angled toward the central vertical plane P-P as the first and second arms 131, 132 rotate about their respective pivot axes A₁-A₁, A₂-A₂, A₃-A₃, A₄-A₄. As can be seen, the door 110 translates with respect to the central vertical plane P-P as it rotates. Finally, as shown in FIG. 23, the door 110 is transitioned from the partially open position to the open position. As noted above, the stopper 139 prevents further opening of the door 110, such that the open position is a fully open position. The first arm 131 engages the stopper 139 and the first and second arms 131, 132 have fully pivoted about their respective pivot axes A₁-A₁, A₂-A₂, A₃-A₃, A₄-A₄. The door 110 is completely on one side of the central vertical plane P-P as a result of the translation provided by the mounting assembly 130. The acute angle θ is formed between the central vertical plane P-P and the mirror plane M-M.

In yet other configurations, one or more of the arms 131, 132 may utilize a sliding joint instead of a purely rotating joint to enable the rotation and translation of the door 110. For instance, the first arm 131 may engage a slot in the housing 160 which enables the door 110 to rotate and translate about the central vertical plane P-P. In addition, combinations of rotating and sliding joints are contemplated to allow a variety of movement profiles which still achieve rotation and translation as desired.

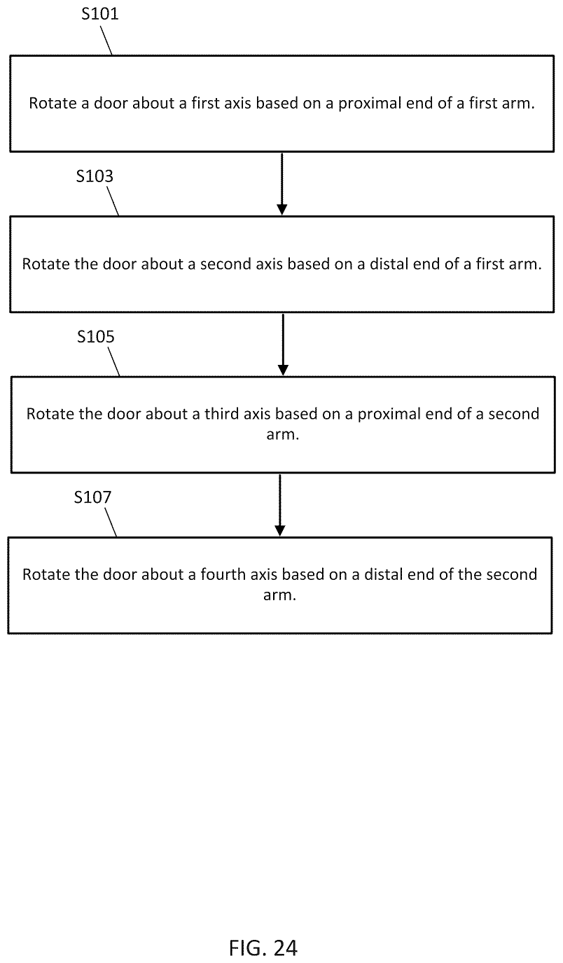

FIG. 24 illustrates a method for operation of the door 110 of the cabinet system. Additional, different, or fewer acts may be included.

At act S101, rotating a door 110 of the cabinet relative to the storage housing 160 about a first axis based on a first end (e.g., proximal end 133) of a first arm 131 of the mounting assembly 130 that is coupled housing 160. The first axis is fixed relative to the housing 160.

At act S103, rotating the door 110 of the cabinet relative to the storage housing 160 about a second axis based on a second end (e.g., distal end 134) of the first arm 131 of the mounting assembly 130 that is coupled to the door 110. The second axis is extended through mounts 120 of the door 110 or mounts of the housing 160. The second axis is fixed relative to the door 110.

At act S105, rotating the door 110 of the cabinet relative to the storage housing 160 about a third is based on a first end (e.g., proximal end 135) of a second arm 132 of the mounting assembly 130 that is coupled housing 160. The third axis is fixed relative to the housing 160.

At act S107, rotating the door 110 of the cabinet relative to the storage housing 160 about a fourth axis based on a second end (e.g., distal end 136) of the second arm 132 of the mounting assembly 130 that is coupled to the door 110. The second axis is extended through mounts 120 of the door 110 or mounts of the housing 160. The second axis is fixed relative to the door 110.

Movement of the door 110 about the first axis, second axis, third axis, and fourth axis reveals a storage space 162 behind the door 110.

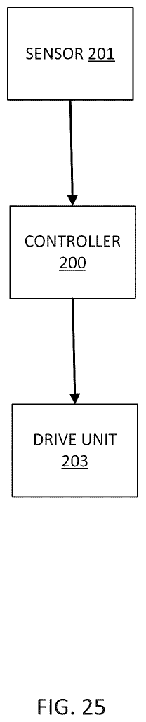

FIG. 25 illustrates a block diagram for a control system for the cabinet apparatus. The control system includes a sensor 201, a controller 200, and a drive unit 203. Additional, different, or fewer components may be included.

The sensor 201 may detect a user in proximity to the cabinet apparatus. The sensor data may describe whether or not a user is present within a predetermined distance (e.g., sensor range) of the cabinet apparatus. The sensor 201 may detect one or more types of gestures made by the user. One gesture may instruct the controller 200 to open the door. One gesture may instruct the controller 200 to close the door. Various gestures may instruct the controller 200 to move the door 110 to a predetermined orientation. The predetermined orientation may include a translation distance and a rotation angle for the door 110.

The sensor 201 may detect a position of the door 110 relative to the housing 160. The senor data may represent one or any combination of the position of the door 110, the first arm 131, or the second arm 132 with respect to the first axis, second axis, third axis, and fourth axis. Thus, the sensor data may include one or more angles.

Based on the sensor data, the controller 200 generates an instruction or command for the drive unit 203. The instruction may include a specific position to place the door. The command may include a relative position (e.g., change in angle, change in translation) for the door 110 to be moved relative to its current position.

The drive unit 203 may include one or more solenoids or one or more motors. The drive unit 203 may include a combination of motors and solenoids. One drive unit 203 may operate the first arm 131 with respect to the housing 160. Another drive unit 203 may operate the second arm 132 with respect to the housing 160.

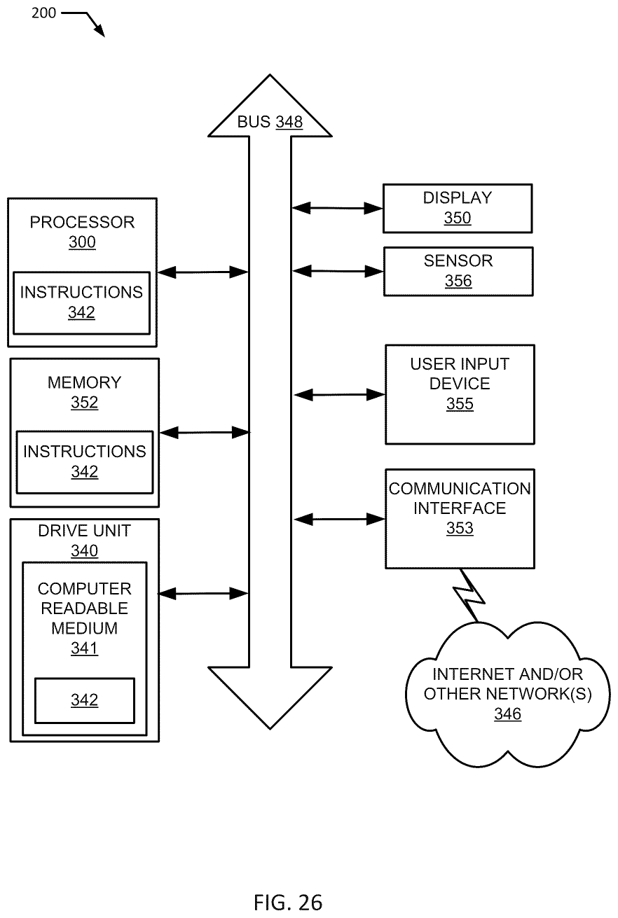

FIG. 26 illustrates a block diagram for the controller 200 of FIG. 25. The controller 200 may include a processor 300, a memory 352, and a communication interface 353 for interfacing with devices or to the internet and/or other networks 346. In addition to the communication interface 353, a sensor interface may be configured to receive data from the sensors described herein or data from any source. The components of the control system 400 may communicate using bus 348. The controller 200 may be connected to a workstation or another external device (e.g., control panel) and/or a database for receiving user inputs, system characteristics, and any of the values described herein.

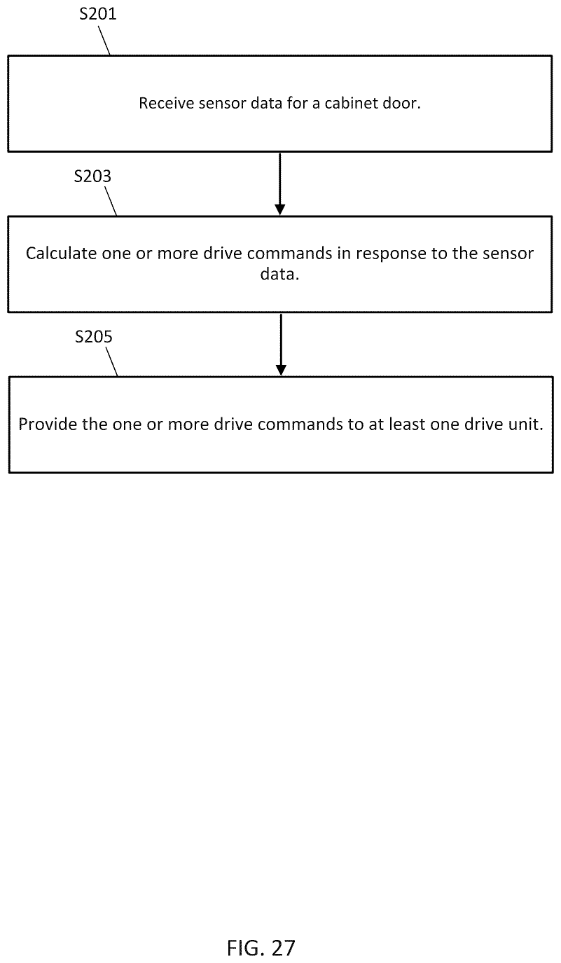

FIG. 27 illustrates a flowchart for the operation of the controller of FIG. 26. Additional, different, or fewer acts may be included.

At act S201, the controller 200 (e.g., processor 300) receives sensor data associated with a cabinet door.

At act S203, the controller 200 (e.g., processor 300) calculates one or more drive commands in response to the sensor data. The drive commands may provide updated positions or destinations position for multiple pivot axes related to the cabinet door. For example, a first drive command may specify a translation and/or rotation of a first pivot point for the cabinet door, a second drive command may specify a translation and/or rotation of a second pivot point for the cabinet door, a third drive command may specify a translation and/or rotation of a third pivot point for the cabinet door, and a fourth drive command may specify a translation and/or rotation of a fourth pivot point for the cabinet door. Each of the translation distances may be implemented by a translation drive unit such as a solenoid but motors and other mechanisms may be used. Each of the rotation angles may be implemented using a stepper motor but other mechanisms may be used.

At act S205, the controller 200 (e.g., processor 300) provides the one or more drive commands to the appropriate drive units. In one example, an aggregate command may be used. The aggregate command man included an address field for each of the multiple drive units. The associate command may be written to the corresponding address field in the aggregate command.

In an optional alternative or addition to act S205, the controller 200 may generate a lighting command. The lighting command may be provided to any of the lights or LEDs described herein. The lighting command may be provided to a particular light in response to a position of the detected user, the detected gesture, or a commanded position of the cabinet door.

Optionally, the control system 200 may include an input device 355 and/or a sensing circuit in communication with any of the sensors. The sensing circuit receives sensor measurements from as described above. The input device 355 may include a switch (e.g., actuator), a touchscreen coupled to or integrated with, a keyboard, a remote, a microphone for voice inputs, a camera for gesture inputs, and/or another mechanism. The user may enter a position for the cabinet door using the input device 355. The user may specify a default open position using the input device 355.

Optionally, the control system 200 may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be supported by any of the components described herein. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, memory 298 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed. Furthermore, to the extent that the term “or” is employed (e.g., <A> or <B>) it is intended to mean “<A> or <B> or both.” When the intent is to indicate “only A or B but not both” then the term “only A or B but not both” will be employed.

While the inventions have been described with respect to specific examples including presently preferred modes of carrying out the inventions, those skilled in the art will appreciate that there are numerous variations and permutations of the above described systems and techniques. It is to be understood that other embodiments may be utilized, and structural and functional modifications may be made without departing from the scope of the present inventions. Thus, the spirit and scope of the inventions should be construed broadly as set forth in the appended claims.

What is claimed is:

1. A cabinet apparatus comprising:
a housing extending along a central vertical plane, the housing defining a storage space and a front access opening into the storage space; and
a door comprising a mirror having a front surface defining a mirror plane;
the door movably mounted to the housing to be alterable between:
(1) a closed position in which the door encloses the front access opening and the front surface of the mirror faces away from the housing; and
(2) an open position in which the storage space is accessible via the access opening, the front surface of the mirror opposes the central vertical plane, and an acute inclusive angle is formed between the central vertical plane and the mirror plane.

2. The cabinet apparatus according to claim 1 wherein the housing comprises an inner edge defining the access opening, the inner edge lying in a first plane that is orthogonal to the central vertical plane; and wherein when the door is in the closed position, the mirror plane is substantially parallel to the first plane.

3. The cabinet apparatus according to claim 2 wherein the door comprises a first lateral edge portion and a second lateral edge portion opposite the first lateral edge portion; and wherein the first lateral edge portion is on one side of the central vertical plane when the door is in the closed position and on an opposite side central vertical plane when the door is in the open position.

4. The cabinet apparatus according to claim 3 wherein the second lateral edge portion is a first orthogonal distance from the central vertical plane when the door is in the closed position and a second orthogonal distance from the central vertical plane when the door is in the open position, the second orthogonal distance being greater than the first orthogonal distance.

5. The cabinet apparatus according to claim 4 further comprising:
a mounting assembly movably mounting the door to the housing, the mounting assembly configured to both translate and rotate the door when moving between the closed and open positions.

6. The cabinet apparatus according to claim 5 wherein the mounting assembly comprises a first arm having a first length and a second arm having a second length that is greater than the first length.

7. The cabinet apparatus according to claim 6 wherein:
the first arm has a proximal end pivotably coupled to the housing to allow relative rotation about a first pivot axis and a distal end pivotably coupled to the door to be allow relative rotation about a second pivot axis; and
the second arm has a proximal end pivotably coupled to the housing to allow relative rotation about a third pivot axis and a distal end pivotably coupled to the door to be allow relative rotation about a fourth pivot axis.

8. The cabinet apparatus according to claim 7 wherein the first and third pivot axes are fixed relative to the housing and the second and fourth pivot axes are fixed relative to the door.

9. The cabinet apparatus according to any one of claim 8 wherein the first pivot axis is located a third orthogonal distance from the central vertical plane and the third pivot axis is located a fourth orthogonal distance from the central vertical plane, the fourth orthogonal distance greater than the third orthogonal distance.

10. The cabinet apparatus according to claim 1 further comprising:
a stopper configured to prevent the door from being moved beyond the open position.

11. The cabinet apparatus according to claim 1 wherein the open position is a fully-open position and the acute angle is in a range of 30 to 60 degrees.

12. The cabinet apparatus according to claim 1 wherein the door further comprises a light source configured to emit light outward from the mirror plane.

13. The cabinet apparatus according to claim 12 wherein the light source is positioned behind a panel of the mirror and is configured to emit light from the front surface of the mirror.

14. The cabinet apparatus according to claim 13 wherein the door is free of any light source that emits light from a rear surface of the door.

15. A cabinet apparatus comprising:
a housing extending along a central vertical plane, the housing defining a storage space and an access opening into the storage space;
a door comprising a mirror having a front surface defining a mirror plane;
a mounting assembly movably mounting the door to the housing, the mounting assembly comprising:
a first arm having a first length, the first arm having:
a proximal end pivotably coupled to the housing to allow the first arm to rotate relative to the housing about a first pivot axis; and
a distal end pivotably coupled to the door to allow the first arm to rotate relative to the door about a second pivot axis; and
a second arm having a second length that is greater than the first length, the second arm comprising:
a proximal end pivotably coupled to the housing to allow the second arm to rotate relative to the housing about a third pivot axis; and
a distal end pivotably coupled to the door to allow the second arm to rotate relative to the door about a fourth pivot axis.

16. The cabinet apparatus according to claim 15 further comprising:
a stopper configured to prevent the door from being moved beyond a open position.

17. The cabinet apparatus according to claim 16 wherein and the open position includes an angle in a range of 30 to 60 degrees.

18. The cabinet apparatus according to claim 15 wherein the door further comprises a light source configured to emit light outward from the mirror plane.

19. The cabinet apparatus according to claim 18 wherein the light source is positioned behind a panel of the mirror and is configured to emit light from the front surface of the mirror.

20. A method of operating a cabinet apparatus including a mirror, the method comprising:
rotating a door coupled to the mirror for the cabinet apparatus about a first axis based on a proximal end of a first arm;
rotating the door for the cabinet apparatus about a second axis based on a distal end of the first arm;
rotating the door for the cabinet apparatus about a third axis based on a proximal end of a second arm; and
rotating the door for the cabinet apparatus about a fourth axis based on a distal end of the second arm,
wherein a storage space behind the door and mirror is opened based on rotation of the door about the first axis, the second axis, the third axis, and the fourth axis.
